(19) United States
(12) Patent Application Publication
(10) Pub. No.: US 2025/0329127 A1
(43) Pub. Date: Oct. 23, 2025

(54) METHOD OF OPERATING A CAMERA ASSEMBLY IN A REFRIGERATOR APPLIANCE

(71) Applicant: Haier US Appliance Solutions, Inc., Wilmington, DE (US)

(72) Inventors: MyungGeon Chung, Seoul (KR); Won Seok Shin, Seoul (KR)

(21) Appl. No.: 18/641,709

(22) Filed: Apr. 22, 2024

(51) Int. Cl. G06V 10/26; F25D 29/00; G06T 7/11

(52) U.S. Cl. CPC G06V 10/26; F25D 29/00; G06T 7/11; F25D 2400/361; F25D 2500/06; F25D 2700/02; F25D 2700/06

(57) ABSTRACT

A refrigerator appliance includes a cabinet defining a chilled chamber, a door being rotatably hinged to the cabinet to provide selective access to the chilled chamber, a camera assembly mounted to the cabinet for monitoring the chilled chamber, and a controller operably coupled to the camera assembly. The controller is configured to obtain one or more images using the camera assembly, analyze the one or more images using one or more machine learning image recognition processes to identify a tilted item, and providing a user notification in response to identifying the tilted item.

### FIELD OF THE INVENTION

The present subject matter relates generally to refrigerator appliances, and more particularly methods for operating a camera assembly in a refrigerator appliance.

### BACKGROUND OF THE INVENTION

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

Notably, items are frequently placed within the chilled chamber on or within racks, bins, shelves, or drawers in an unstable manner. For example, bottles may be placed in the fridge such that they are tilted, are leaning against another item, or are otherwise not sitting on a stable base. In addition, slamming the refrigerator door may cause upright items to end up in a tilted position. When accessing items within the refrigerator, users often inadvertently disturb the tilted item and/or an item adjacent to or supporting the tilted item. In addition, the tilted item may be disturbed when a user quickly opens or closes the door. In such instances, there is a high risk that the tilted bottle will fall over, potentially resulting in broken glass, spilled liquids (if item is not secured properly), etc.

Accordingly, a refrigerator appliance with features for reducing the likelihood of spillage or breakage due to improperly stored items would be useful. More particularly, a refrigerator appliance including a camera for detecting tilted items and initiating corrective action would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a refrigerator appliance is provided. The refrigerator appliance includes a chilled chamber, a door to provide selective access to the chilled chamber, and a camera assembly for monitoring the chilled chamber. The method includes obtaining one or more images using the camera assembly, analyzing the one or more images using one or more machine learning image recognition processes to identify a tilted item, and providing a user notification in response to identifying the tilted item.

In another exemplary embodiment, a refrigerator appliance is provided including a cabinet defining a chilled chamber, a door being rotatably hinged to the cabinet to provide selective access to the chilled chamber, a camera assembly mounted to the cabinet for monitoring the chilled chamber, and a controller operably coupled to the camera assembly. The controller is configured to obtain one or more images using the camera assembly, analyze the one or more images using one or more machine learning image recognition processes to identify a tilted item, and provide a user notification in response to identifying the tilted item.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an example embodiment of the present subject matter.

FIG. 2 provides a perspective view of the example refrigerator appliance of FIG. 1, with the doors of the fresh food chamber shown in an open position to reveal a camera assembly according to an example embodiment of the present subject matter.

FIG. 3 provides a method for operating the example camera assembly of FIG. 2 according to an example embodiment of the present subject matter.

FIG. 4 provides an image obtained using the example camera assembly of FIG. 2 according to an example embodiment of the present subject matter.

FIG. 5 provides a flow diagram of a tilted bottle detection method that may be implemented with the example camera assembly of FIG. 2 according to an example embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

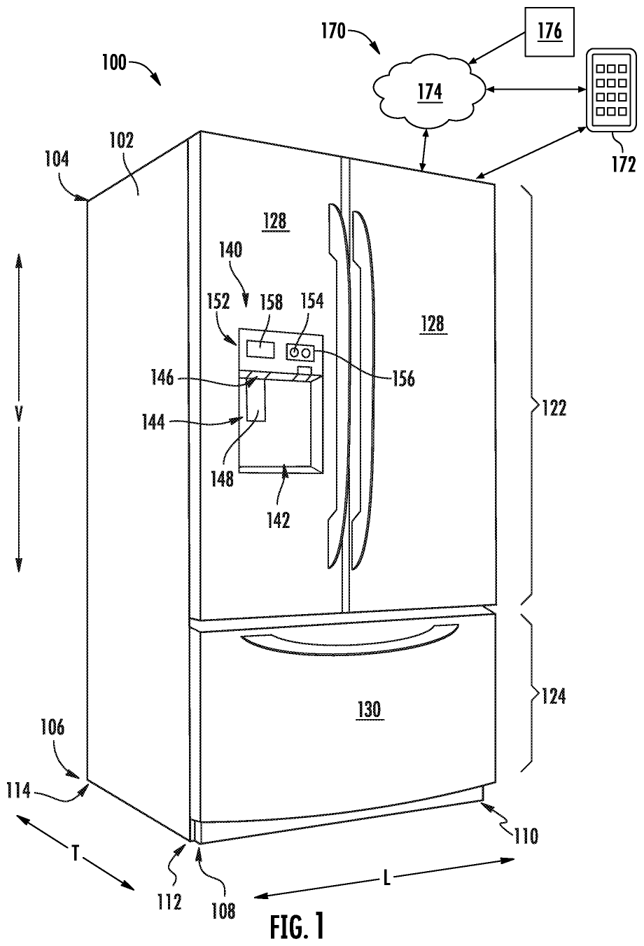

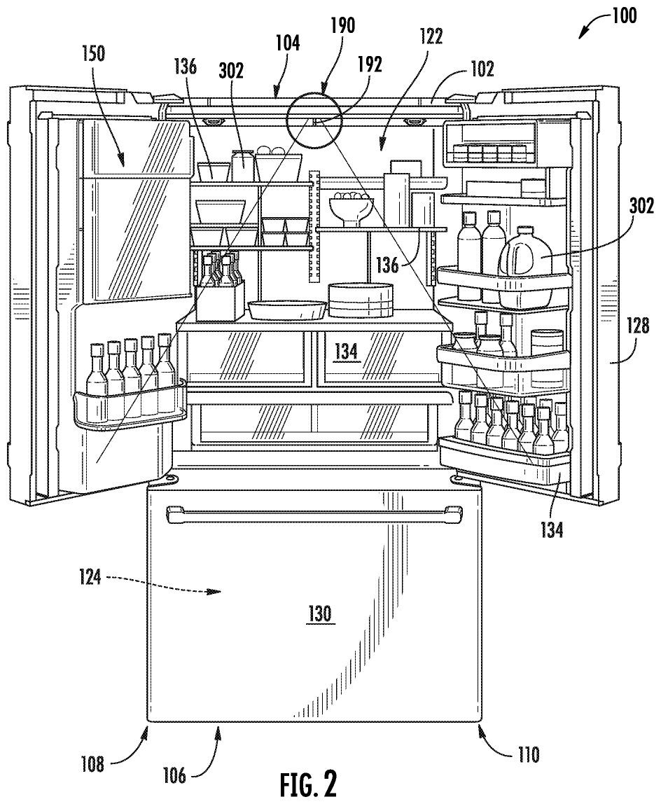

Referring now to the figures, an exemplary appliance will be described in accordance with exemplary aspects of the present subject matter. Specifically, FIG. 1 provides a perspective view of an exemplary refrigerator appliance 100 and FIG. 2 illustrates refrigerator appliance 100 with some of the doors in the open position. As illustrated, refrigerator appliance 100 generally defines a vertical direction V, a lateral direction L, and a transverse direction T, each of which is mutually perpendicular, such that an orthogonal coordinate system is generally defined.

According to exemplary embodiments, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 102.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. In general, refrigerator doors 128 form a seal over a front opening 132 defined by cabinet 102 (e.g., extending within a plane defined by the vertical direction V and the lateral direction L). In this regard, a user may place items within fresh food chamber 122 through front opening 132 when refrigerator doors 128 are open and may then close refrigerator doors 128 to facilitate climate control. Refrigerator doors 128 and freezer door 130 are shown in the closed configuration in FIG. 1. One skilled in the art will appreciate that other chamber and door configurations are possible and within the scope of the present invention.

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible by a processing device, including instructions that can be executed by processing device. Optionally, the instructions can be software or any set of instructions and/or data that when executed by the processing device, cause the processing device to perform operations.

Referring still to FIG. 1, a schematic diagram of an external communication system 170 will be described according to an exemplary embodiment of the present subject matter. In general, external communication system 170 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as an external device 172. As described in more detail below, these communications may be facilitated using a wired or wireless connection, such as via a network 174. In general, external device 172 may be any suitable device separate from refrigerator appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with refrigerator appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control refrigerator appliance 100, etc. In addition, external device 172 and remote server 176 may communicate with refrigerator appliance 100 to communicate similar information. According to exemplary embodiments, remote server 176 may be configured to receive and analyze images obtained by camera assembly 190.

In general, communication between refrigerator appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring now generally to FIG. 2, refrigerator appliance 100 may further include a camera assembly 190 that is generally positioned and configured for obtaining images of refrigerator appliance 100 during operation. Specifically, according to the illustrated embodiment, camera assembly 190 includes one or more cameras 192 that are mounted to cabinet 102, to doors 128, or are otherwise positioned in view of fresh food chamber 122. Although camera assembly 190 is described herein as being used to monitor fresh food chamber 122 of refrigerator appliance 100, it should be appreciated that aspects of the present subject matter may be used to monitor any other suitable regions of any other suitable appliance, e.g., such as freezer chamber 124. As best shown in FIG. 2, a camera 192 of camera assembly 190 is mounted to cabinet 102 at front opening 132 of fresh food chamber 122 and is oriented to have a field of view directed across front opening 132 and/or into fresh food chamber 122.

Although a single camera 192 is illustrated in FIG. 2, it should be appreciated that camera assembly 190 may include a plurality of cameras 192 positioned within cabinet 102, wherein each of the plurality of cameras 192 has a specified monitoring zone or range positioned around fresh food chamber 122. In this regard, for example, the field of view of each camera 192 may be limited to or focused on a specific area within fresh food chamber 122. According to example embodiments, camera assembly 190 may include a plurality of cameras 192 that are mounted to a sidewall of fresh food chamber 122 and may be spaced apart along the vertical direction V to cover different monitoring zones.

Notably, however, it may be desirable to position each camera 192 proximate front opening 132 of fresh food chamber 122 and orient each camera 192 such that the field-of-view is directed into fresh food chamber 122. In this manner, privacy concerns related to obtaining images of the user of the appliance 100 may be mitigated or avoided altogether. According to exemplary embodiments, camera assembly 190 may be used to facilitate an inventory management process for refrigerator appliance 100. As such, each camera 192 may be positioned at an opening to fresh food chamber 122 to monitor food items (identified generally as objects 302) that are positioned within fresh food chamber 122.

According to still other embodiments, each camera 192 may be oriented in any other suitable manner for monitoring any other suitable region within or around refrigerator appliance 100. It should be appreciated that according to alternative embodiments, camera assembly 190 may include any suitable number, type, size, and configuration of camera(s) 192 for obtaining images of any suitable areas or regions within or around refrigerator appliance 100. In addition, it should be appreciated that each camera 192 may include features for adjusting the field-of-view and/or orientation.

It should be appreciated that the images obtained by camera assembly 190 may vary in number, frequency, angle, resolution, detail, etc. in order to improve the clarity of the particular regions surrounding or within refrigerator appliance 100. In addition, according to exemplary embodiments, controller 156 may be configured for illuminating the chilled chamber using one or more light sources prior to obtaining images. Notably, controller 156 of refrigerator appliance 100 (or any other suitable dedicated controller) may be communicatively coupled to camera assembly 190 and may be programmed or configured for analyzing the images obtained by camera assembly 190, e.g., in order to identify items positioned within refrigerator appliance 100, as described in detail below.

In general, controller 136 may be operably coupled to camera assembly 190 for analyzing one or more images obtained by camera assembly 190 to extract useful information regarding objects 302 located within fresh food chamber 122. Notably, this analysis may be performed locally (e.g., on controller 156) or may be transmitted to a remote server (e.g., remote server 176 via external communication network 170) for analysis. Such analysis is intended to facilitate inventory management, e.g., by identifying a food item within the chilled chamber.

Now that the construction and configuration of refrigerator appliance 100 and camera assembly 190 have been presented according to an exemplary embodiment of the present subject matter, an exemplary method 200 for operating a camera assembly 190 is provided. Method 200 can be used to operate camera assembly 190, or to operate any other suitable camera assembly for detecting tilted items within a refrigerator appliance. In this regard, for example, controller 156 may be configured for implementing method 200. However, it should be appreciated that the exemplary method 200 is discussed herein only to describe exemplary aspects of the present subject matter, and is not intended to be limiting.

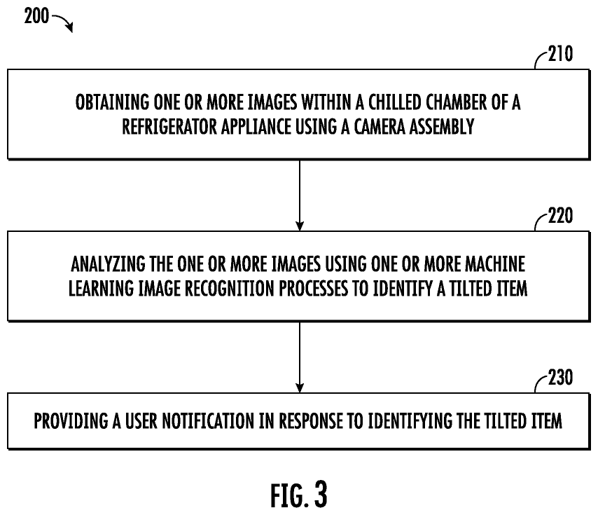

As shown in FIG. 3, method 200 includes, at step 210, obtaining one or more images within a chilled chamber of the refrigerator appliance using a camera assembly. For example, continuing the example from above, camera assembly 190 of refrigerator appliance 100 may obtain one or more images within fresh food chamber 122 of refrigerator appliance 100. In this regard, referring now briefly to FIG. 4, an example image 300 obtained by camera assembly 190 is provided to facilitate discussion of aspects of the present subject matter. As shown, image 300 may include in its field-of-view a plurality of objects (e.g., identified herein generally by reference numeral 302). Although image 300 is illustrated as being obtained within fresh food chamber 122, it should be appreciated that camera assembly 190 of refrigerator appliance 100 may obtain one or more images within freezer chamber 124 or any other zone or region within or around refrigerator appliance 100.

The images obtained by camera assembly 190 may include one or more still images, one or more video clips, or any other suitable type and number of images suitable for identification of objects 302. Although the term “image” is used herein, it should be appreciated that according to example embodiments, camera assembly 190 may take any suitable number or sequence of two-dimensional images, videos, or other visual representations of fresh food chamber 122. For example, the one or more images may include a video feed or series of sequential static images obtained by camera assembly 190 that may be transmitted to the controller 156 (e.g., as a data signal) for analysis or other manipulation. These obtained images may vary in number, frequency, angle, field-of-view, resolution, detail, etc.

Notably, camera assembly 190 may obtain images upon any suitable trigger. For example, according to example embodiments, refrigerator appliance 100 may include a door switch that detects when refrigerator door 128 is moved from an open position to a closed position, at which point camera assembly 190 may begin obtaining one or more images. According to exemplary embodiments, the one or more images may be obtained continuously or periodically after refrigerator doors 128 are closed. In addition, according to exemplary embodiments, controller 156 may be configured for illuminating a refrigerator light (not shown) while obtaining the one or more images. Other suitable triggers are possible and within the scope of the present subject matter.

Step 220 may generally include analyzing the one or more images using one or more machine learning image recognition processes to identify a tilted item. For example, analyzing the one or more images comprises using an AI object detection algorithm or model. As used herein, the terms “object detection model” and the like are generally intended to refer to any AI or machine learning methods or algorithms for implementing object detection or identification—i.e., recognizing and locating various objects within visual data or images and understanding the relationship between the objects and their surroundings.

In general, these object detection models perform real-time object detection by identifying specific objects in videos, live feeds, images, or other visual data. These models may use features learned by a deep convolutional neural network (or any other suitable machine learning technique) to detect objects located in an image. These models provide accurate and rapid object detection in computer vision applications, particularly where real-time processing is desirable. For example, a publicly available image segmentation model includes the You Only Look Once (YOLO) model developed by Joseph Redmon et al. and which has seen several versions or iterations over the years. Although the YOLO model is referred to specifically herein, it should be appreciated that the present subject matter is not limited to this particular model.

In addition, analyzing the one or more images may include using an artificial intelligence (AI) image segmentation model. As used herein, the terms “image segmentation model” and the like are generally intended to refer to any AI or machine learning methods or algorithms for implementing image segmentation—i.e., identifying which image pixels belong to an object. These image segmentation models may be trained with large datasets in order to be capable of detecting or identifying any given object. Furthermore, these segmentation models may be capable of generating masks for any object in any image or any video. For example, a publicly available image segmentation model includes the Segment Anything Model (SAM) provided by Meta Platforms, Inc. or Facebook, Inc. Although the SAM model is referred to specifically herein, it should be appreciated that the present subject matter is not limited to this particular model.

According to example embodiments, analyzing the one or more images may include the use of any other suitable image processing technique, image recognition process, etc. As used herein, the terms “image analysis” and the like may be used generally to refer to any suitable method of observation, analysis, image decomposition, feature extraction, image segmentation, image classification, etc. of one or more images, videos, or other visual representations of an object. As explained in more detail below, this image analysis may include the implementation of image processing techniques, image recognition techniques, or any suitable combination thereof. This analysis may be performed entirely by controller 156, may be offloaded to a remote server for analysis, may be analyzed with user assistance (e.g., via control panel 152), or may be analyzed in any other suitable manner. According to exemplary embodiments of the present subject matter, the analysis performed at step 220 may include any suitable machine learning image recognition process.

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image. In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 156 based on one or more captured images from one or more cameras). Other image processing techniques are possible and within the scope of the present subject matter.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information-image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

Referring now for example to FIG. 4, implementation of step 220 will be described using image 300. According to an example embodiment, an object detection model (e.g., such as the YOLO model described above) may be used to identify various objects 302 within fresh food chamber 122 and determine whether the item is a tiltable item (e.g., an item that may topple over if placed at a certain angle). For example, the tiltable items may include bottles or other tall items that have an aspect ratio over a specific threshold. It should be appreciated that controller 156 may be programmed to identify tiltable items in any suitable manner.

If a tiltable item is identified, further machine learning models may be used to identify the outline and or tilt angle of the tiltable item. For example, an image segmentation model (e.g., such as the SAM model described above) may be used to identify an outline or area 304 of the tiltable item or tiltable object 302. Moreover, method 200 may include determining a tilt angle 306 of the tiltable item 302, e.g., by comparing the horizontal direction or shelf surface to the sidewall of the tiltable item 302 or a centerline of the tiltable item 302.

If the tilt angle 306 falls below a predetermined threshold, the tiltable item may be classified as a tilted item and corrective action may be taken as described in more detail below. According to example, embodiments, the predetermined threshold angle may be less than 85 degrees, less than 75 degrees, less than 60 degrees, less than 45 degrees, or less, though other thresholds are possible and within the scope of the present subject matter. Other geometries or features of a particular tiltable object 302 may be used to classify a tiltable item or a tilted item, e.g., such as the shape of the container.

Step 230 includes providing a user notification in response to identifying the tilted item. In this regard, if step 220 results in the identification of an item that is tilted and is thus likely to fall over if disturbed, step 230 may include providing useful notifications and/or information to a user of refrigerator appliance 100 so that they may take corrective action to prevent undesirable breakage or spillage. According to example embodiments, user notification may be provided through control panel 152 of refrigerator appliance 100. According to still other embodiments, the user notification may be provided through an external device 172 through network 174 (e.g., using a software application on a user's mobile phone).

It should be appreciated that the user notification may include any images, instructions, or other information useful to a user for correcting issues related to the tiltable item identified within the chilled chamber. For example, the user notification may include at least one of the one or more images obtained by camera assembly 190. In addition, according to an example embodiment, the at least one image provided to the user may be edited or marked with a boundary, marker, or other identifier of the tilted item (e.g., superimposed on the image). In this manner, the user may be quickly informed of the location of the tilted item for a quick resolution of the issue.

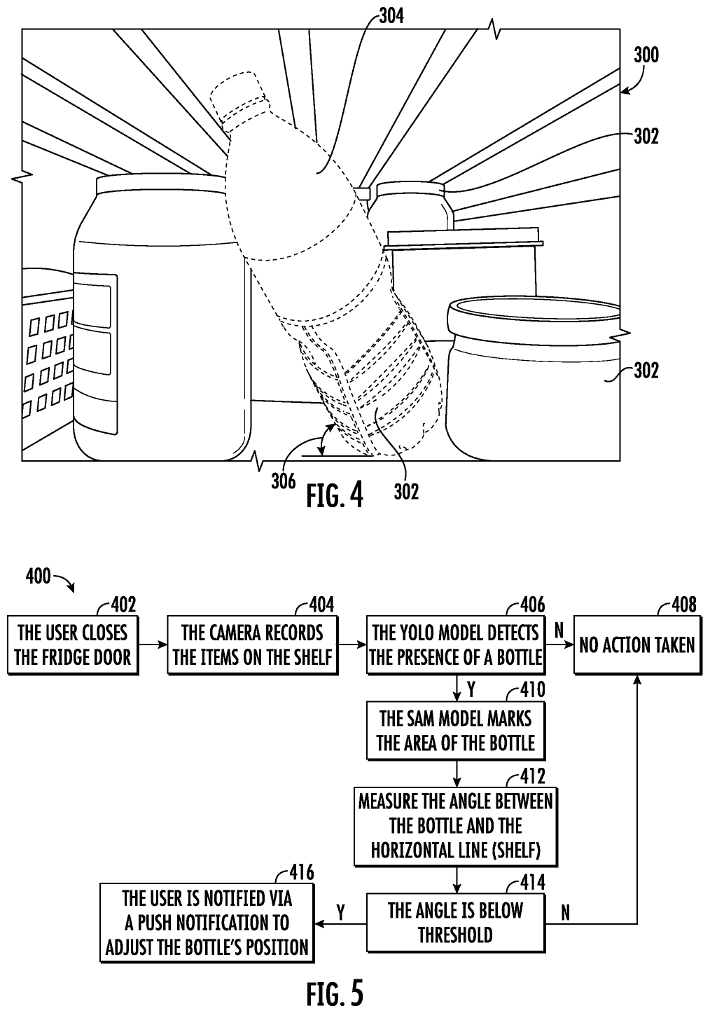

Referring now specifically to FIG. 5, an example flow diagram or control algorithm 400 for implementing a tilted object detection process will be described according to an example embodiment. As shown, step 402 includes determining that the door of the refrigerator appliance has been closed. Step 404 includes using the camera assembly to record items stored within the chilled chamber. Step 406 comprises using an object detection model (e.g., such as the YOLO model described above) to identify the presence of a bottle or another tiltable item (e.g., an item that is prone to tipping if placed at a certain angle). If the object detection model does not detect a tiltable item, method 400 may end at step 408 where no action is taken.

By contrast, if step 406 results in the detection of a tiltable item, step 410 may include performing an image segmentation process (e.g., such as the SAM model described above) to mark or outline the area of the tiltable item. Step 412 includes measuring an angle between the bottle and a horizontal line (e.g., the shelf). In this regard, the centerline or a boundary line of the tiltable item may be used to determine a tilt angle between the tiltable item and the shelf on which it is stored. Step 414 includes determining whether the tilt angle is below a predetermined threshold (e.g., where 90 degrees would be an upright bottle). If the tilt angle is not below the threshold, no action is taken at step 408. By contrast, if the tilt angle is below the threshold, step 416 may include providing a push notification to the user requesting that they reposition the tilted item.

FIGS. 3 and 5 depict example control methods having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using camera assembly 190 as an example, it should be appreciated that these methods may be applied to the operation of any suitable appliance and/or camera assembly.

As explained herein, aspects of the present subject matter are generally directed to a method for users to correct the position of tilted bottles or other improperly placed items in a refrigerator. Users may sometimes place a tilted bottle inside the chilled chamber, and when the user slams the refrigerator door or touches the item next to the tilted bottle, the tilted bottle may topple or fall. In this scenario, if the bottle is made of glass, it may break, and if the bottle cap is not closed properly, the liquid inside it may spill. Accordingly, the present subject matter proposes utilizing image processing artificial intelligence (AI) models such as the SAM (Segment Anything Model) and Yolo (You Only Look Once) model to calculate the degree of tilt of the bottle. If the angle of tilts falls below a certain threshold, the fridge may identify the bottle as a tilted bottle and may notify the user through a push notification on the smart home application, thereby preventing the tilted bottle from falling to the ground or toppling onto the shelf.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a refrigerator appliance, the refrigerator appliance comprising a chilled chamber, a door to provide selective access to the chilled chamber, and a camera assembly for monitoring the chilled chamber, the method comprising:
obtaining one or more images using the camera assembly;
analyzing the one or more images using one or more machine learning image recognition processes to identify a tilted item; and
providing a user notification in response to identifying the tilted item.

2. The method of claim 1, wherein the refrigerator appliance further comprises a door sensor, the method comprising:
obtaining the one or more images after the door sensor indicates that the door has been closed.

3. The method of claim 1, wherein analyzing the one or more images using the one or more machine learning image recognition processes comprises:
implementing at least one of an object detection model or an image segmentation model to determine an angle of tilt of the tilted item, the angle of tile being measured between a center line of the tilted item and a horizontal line.

4. The method of claim 1, wherein analyzing the one or more images using the one or more machine learning image recognition processes comprises implementing an object detection model to identify a presence of a tiltable item.

5. The method of claim 4, wherein analyzing the one or more images using the one or more machine learning image recognition processes comprises implementing an image segmentation model to identify an area of the tiltable item and determine an angle of tilt of the tiltable item.

6. The method of claim 5, wherein identifying the tilted item comprises determining that the angle of tilt of the tiltable item falls below a predetermined threshold angle.

7. The method of claim 6, wherein the predetermined threshold angle is 75 degrees.

8. The method of claim 6, wherein the predetermined threshold angle is 60 degrees.

9. The method of claim 1, wherein the refrigerator appliance further comprises a user interface panel, and wherein the user notification is provided through the user interface panel.

10. The method of claim 1, wherein the user notification is provided through a remote device through an external network.

11. The method of claim 1, wherein the user notification comprises at least one image of the one or more images for display to a user along with a boundary or marker of the tilted item superimposed on the at least one image.

12. A refrigerator appliance comprising:
a cabinet defining a chilled chamber;
a door being rotatably hinged to the cabinet to provide selective access to the chilled chamber;
a camera assembly mounted to the cabinet for monitoring the chilled chamber; and
a controller operably coupled to the camera assembly, the controller being configured to:
obtain one or more images using the camera assembly;
analyze the one or more images using one or more machine learning image recognition processes to identify a tilted item; and
provide a user notification in response to identifying the tilted item.

13. The refrigerator appliance of claim 12, further comprising:
a door sensor, wherein the controller is configured for obtaining the one or more images after the door sensor indicates that the door has been closed.

14. The refrigerator appliance of claim 12, wherein analyzing the one or more images using the one or more machine learning image recognition processes comprises:
implementing at least one of an object detection model or an image segmentation model to determine an angle of tilt of the tilted item, the angle of tile being measured between a center line of the tilted item and a horizontal line.

15. The refrigerator appliance of claim 12, wherein analyzing the one or more images using the one or more machine learning image recognition processes comprises implementing an object detection model to identify a presence of a tiltable item.

16. The refrigerator appliance of claim 15, wherein analyzing the one or more images using the one or more machine learning image recognition processes comprises implementing an image segmentation model to identify an area of the tiltable item and determine an angle of tilt of the tiltable item.

17. The refrigerator appliance of claim 16, wherein identifying the tilted item comprises determining that the angle of tilt of the tiltable item falls below a predetermined threshold angle.

18. The refrigerator appliance of claim 17, wherein the predetermined threshold angle is 75 degrees.

19. The refrigerator appliance of claim 12, wherein the refrigerator appliance further comprises a user interface panel, and wherein the user notification is provided through the user interface panel or through a remote device through an external network.

20. The refrigerator appliance of claim 12, wherein the user notification comprises at least one image of the one or more images for display to a user along with a boundary or marker of the tilted item superimposed on the at least one image.
